(19) United States
(12) Patent Application Publication
(10) Pub. No.: US 2022/0113466 A1
(43) Pub. Date: Apr. 14, 2022

(54) OPTICAL APPARATUS AND DISPLAY APPARATUS

(71) Applicant: SONY CORPORATION, TOKYO (JP)

(72) Inventor: TSUTOMU IKEDA, TOKYO (US)

(21) Appl. No.: 17/250,796

(22) PCT Filed: Jun. 28, 2019
(86) PCT No.: PCT/JP2019/025940

§ 371 Date: Mar. 4, 2021

Related U.S. Application Data
(60) Provisional application No. 62/737,413, filed on Sep. 27, 2018.

(51) Int. Cl. F21V 8/00; G02B 27/01

(52) U.S. Cl. CPC G02B 6/0088; G02B 2027/0178; G02B 2027/0174; G02B 27/0172

(57) ABSTRACT

Provided is an optical apparatus (1B) or a display apparatus including: a light guide plate (14); a support portion (16) that supports the light guide plate; a cover portion (17) that covers at least a part of the light guide plate; and a metal portion (18) disposed between the cover portion and at least one of the light guide plate or the support portion.

### TECHNICAL FIELD

The present disclosure relates to an optical apparatus and a display apparatus.

### BACKGROUND ART

An optical apparatus including a light guide plate has been known in the past. For example, Patent Literature 1 below describes an edge-light-type planar light emitting apparatus including a glass light guide plate. Patent Literature 1 discloses a technique of providing an inorganic barrier layer on one main surface of a light guide plate in order to suppress the occurrence of haze on the surface of the light guide plate when the light emitting apparatus is placed under high temperature and humidity for a long time.

### CITATION LIST

### Patent Literature

Patent Literature 1: Japanese Patent Application Laid-open No. 2018-177626

### DISCLOSURE OF INVENTION

### Technical Problem

However, for example, the technique disclosed in Patent Literature 1 has a configuration in which an inorganic barrier layer is provided on a surface of a light guide plate, and may cause a possibility that a manufacturing process of the light guide plate becomes complicated, for example.

In this regard, the present disclosure proposes new and improved optical apparatus and display apparatus capable of easily suppressing the occurrence of haze on the light guide plate.

### Solution to Problem

According to the present disclosure, there is provided an optical apparatus or a display apparatus including: a light guide plate; a support portion that supports the light guide plate; a cover portion that covers at least a part of the light guide plate; and a metal portion disposed between the cover portion and at least one of the light guide plate or the support portion.

According to the present disclosure, since the metal portion absorbs an organic acid, adhesion of the organic acid to the light guide plate is suppressed.

### BRIEF DESCRIPTION OF DRAWINGS

FIG. 1 is an exploded perspective view of an optical unit according to a first embodiment of the present disclosure.

FIG. 2 is a partial cross-sectional view of the optical unit according to the embodiment.

FIG. 3 is a front view of the assembly of an outer cover portion, a support portion, and a metal portion according to the embodiment.

FIG. 4 is a schematic cross-sectional view of the optical unit according to the embodiment.

FIG. 5 is a schematic view of a part of an optical unit according to a comparative example.

FIG. 6 is a schematic view of a part of the optical unit according to the first embodiment of the present disclosure.

FIG. 7 is a side view of a part of a head mounted display according to a second embodiment of the present disclosure.

### MODE(S) FOR CARRYING OUT THE INVENTION

Suitable embodiments of the present disclosure will be described below in detail with reference to the accompanying drawings. Note that in this specification and drawings, constituent elements having substantially the same functional configurations will be denoted by the same reference signs and overlap description thereof will be omitted.

Note that description will be given in the following order.

1. First Embodiment

1.1. Configuration of Optical Apparatus

1.2. Operation and Advantages of Optical Apparatus

2. Second Embodiment (Example Using Optical Apparatus for Head Mounted Display)

### 1. First Embodiment

[1.1. Configuration of Optical Apparatus]

First, an optical apparatus according to a first embodiment of the present disclosure will be described. The optical apparatus according to this embodiment is used for a video display apparatus. The video display apparatus may be a wearable display or a stationary display apparatus. The wearable display may be, for example, a head mounted display (HMD) that is to be mounted on the head of a user. The HMD may be of a transmissive type (see-through type) that displays a display video and light from the outside in an overlapping manner, or may be of a non-transmissive type that blocks light from the outside. The HMD may include a camera for capturing a video of a field of view of the user and may display the video captured by the camera to the user. The stationary display apparatus may be a stationary liquid crystal display apparatus, organic EL display apparatus, or the like.

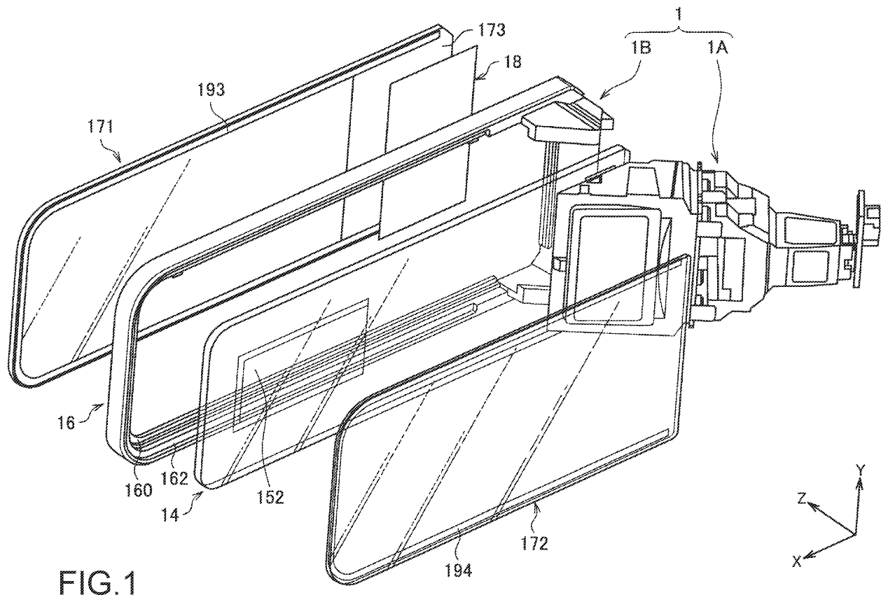

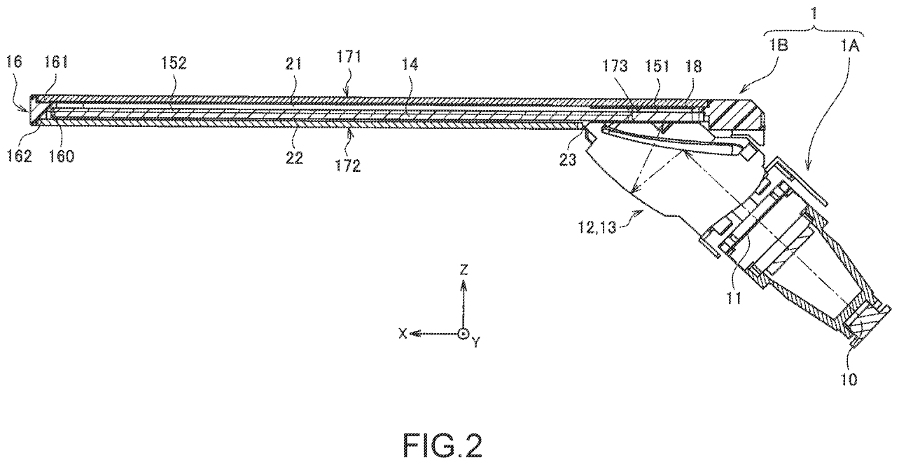

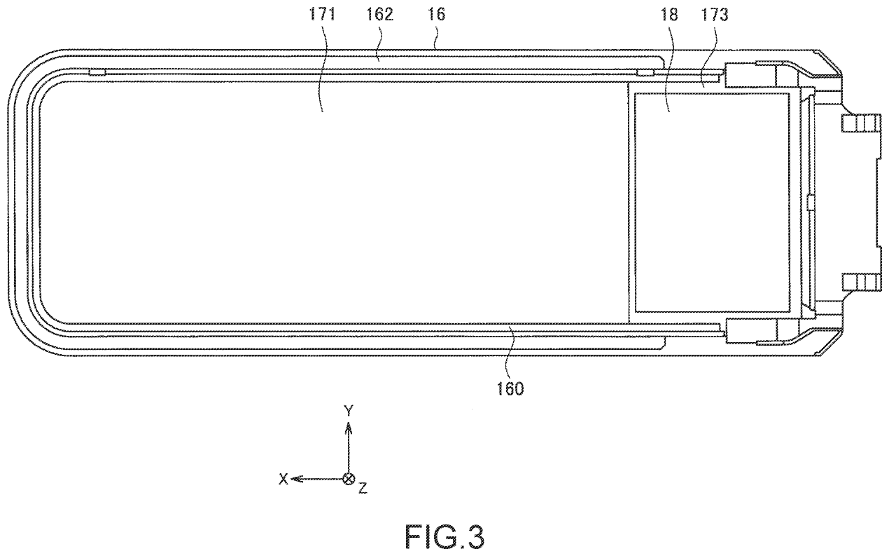

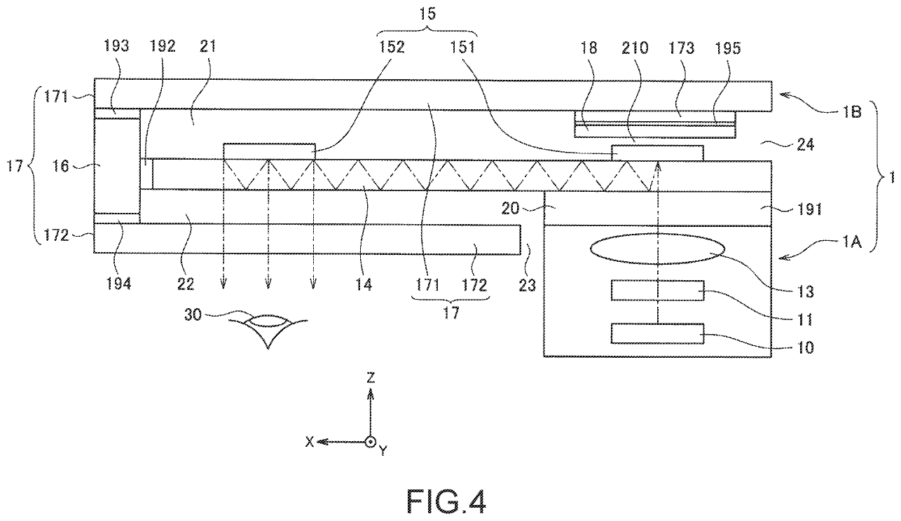

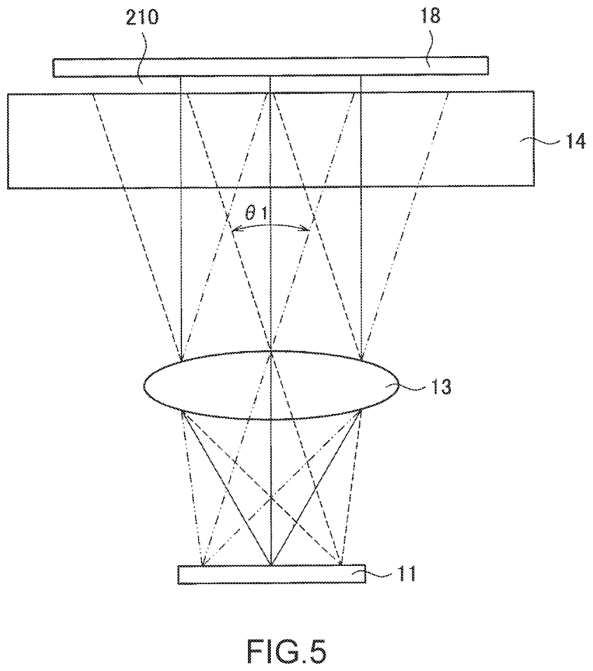

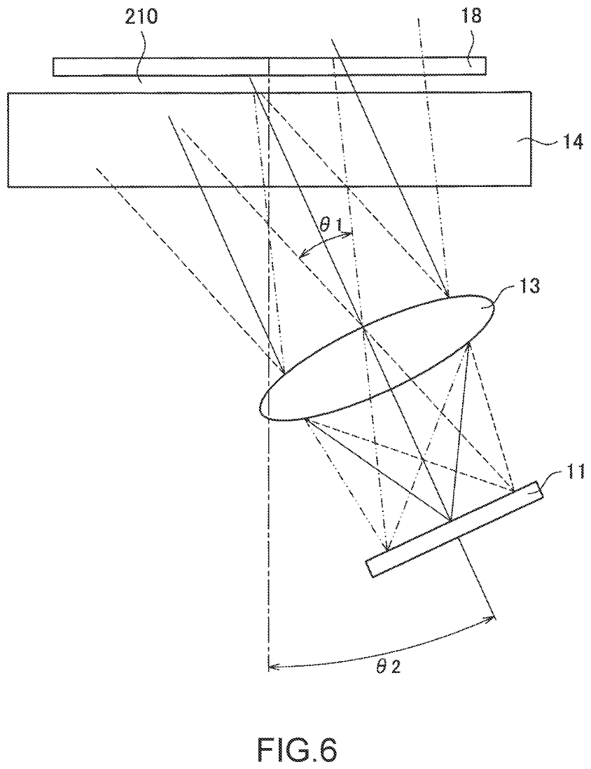

Hereinafter, referring to FIGS. 1 to 6, the configuration of an optical apparatus 1B according to this embodiment will be described. An optical engine 1A is integrally connected to the optical apparatus 1B. Thus, an optical unit 1 is formed. FIG. 1 is an exploded perspective view of the optical unit 1. FIG. 2 is a partial cross-sectional view of the optical unit 1. FIG. 3 is a front view of the assembly of an outer cover portion 171, a support portion 16, and a metal portion 18. FIG. 4 is a schematic cross-sectional view of the optical unit 1. FIGS. 5 and 6 are schematic views of the optical unit 1 for describing the setting of the angle of video light with respect to a light guide plate 14.

As shown in FIGS. 2 and 4, the optical engine 1A includes a light source 10, a display 11, a mirror 12, and a lens 13. In FIG. 2, an exemplary optical path in the optical engine 1A is shown by an arrow of a chain line. The light source 10 is a light emitting element such as a light emitting diode (LED) or a semiconductor laser, and emits light. The display 11 is an element that displays a video, such as a liquid crystal panel. The light from the light source 10 passes through the display 11 and thus becomes video light that is a ray for displaying a video. The mirror 12 is a reflecting mirror that deflects the optical path, such as a prism mirror, and reflects the video light from the display 11 to change its direction. The lens 13 refracts the video light from the display 11 or the mirror 12, and emits the video light as a parallel beam to the optical apparatus 1B, thus functioning as a collimator lens.

As shown in FIGS. 1 to 4, the optical apparatus 1B includes the light guide plate 14, a holographic optical element (HOE) 15, the support portion 16, a cover portion 17, and the metal portion 18. In each figure, a three-dimensional orthogonal coordinate system is provided for convenience of explanation. The X-axis is provided along a longitudinal direction of the light guide plate 14. The Y-axis is provided along a lateral direction of the light guide plate 14. The Z-axis is provided along the normal of a surface of the light guide plate 14.

The light guide plate 14 is a plate-like member that functions as a light guide path for guiding and transmitting light, and is made of glass. The light guide plate 14 may have translucency or may have no translucency. In this specification, the translucency refers to property of transmitting light and includes, for example, property of being transparent or semitransparent and transmitting a specific wavelength.

The optical engine 1A is connected to the light guide plate 14. The optical engine 1A is attached to the inner (the negative-direction side of the Z-axis) surface of the light guide plate 14 on the negative-direction side of the X-axis. As shown in FIG. 4, in the portion of the optical engine 1A facing the light guide plate 14, both sides thereof in the Y-axis direction are bonded to the light guide plate 14 by an adhesive 191. In the portion of the optical engine 1A facing the light guide plate 14, both sides thereof in the X-axis direction are not bonded to the light guide plate 14 by the adhesive 191. A gap 20 is provided between the light guide plate 14 and the optical engine 1A (specifically in a portion sandwiched by the adhesive 191 on both sides in the Y-axis direction).

The holographic optical element (HOE) 15 is an element for changing a propagation state of the light transmitted in the light guide plate 14 and is disposed on the light guide plate 14. The HOE 15 selectively diffracts only a particular wavelength in accordance with the incident angle of the light and transmits the remaining wavelength. For example, the HOE 15 is manufactured integrally with the light guide plate 14 by applying a photopolymer to the surface of the light guide plate 14 and performing laser exposure thereon. The HOE 15 may be of a so-called volume type. As shown in FIGS. 2 and 4, the HOE 15 includes an incident-side HOE 151 and an emission-side HOE 152.

The support portion 16 is a member for supporting the light guide plate 14 and is made of resin. The shape of the support portion 16 is a frame shape surrounding the outer periphery of the light guide plate 14. As shown in FIGS. 1 to 3, a stepped recess 160 that is opened to the negative-direction side of the Z-axis is provided along the inner edge of the support portion 16. As shown in FIG. 2, a stepped recess 161 is provided to the surface of the support portion 16 on the positive-direction side of the Z-axis, along the outer edge of the support portion 16. A stepped recess 162 is provided to the surface of the support portion 16 on the negative-direction side of the Z-axis, along the outer edge of the support portion 16. The outer edge of the light guide plate 14 is disposed in the recess 160 of the support portion 16. As schematically shown in FIG. 4, the light guide plate 14 is attached to the support portion 16 by an adhesive 192.

The cover portion 17 is a protective member for covering the light guide plate 14 and is made of resin. The cover portion 17 includes an outer cover portion 171 and an inner cover portion 172. The outer cover portion 171 and the inner cover portion 172 have translucency. The outer cover portion 171 has a plate shape and is disposed to face the outer (the positive-direction side of the Z-axis) surface of the light guide plate 14. As shown in FIGS. 2 and 4, a gap 21 is provided between the outer cover portion 171 and the light guide plate 14. The inner cover portion 172 has a plate shape and is disposed to face the inner (the negative-direction side of the Z-axis) surface of the light guide plate 14 mainly on the positive-direction side of the X-axis. A gap 22 is provided between the inner cover portion 172 and the light guide plate 14. A gap 23 is provided between the inner cover portion 172 and the optical engine 1A.

As shown in FIG. 2, the outer edge of the outer cover portion 171 is disposed in the recess 161 of the support portion 16. As shown in FIGS. 1 and 4, the outer cover portion 171 is attached to the support portion 16 using a U-shaped double-sided adhesive tape 193 along the recess 161. As shown in FIG. 2, the outer edge of the inner cover portion 172 is disposed in the recess 162 of the support portion 16. As shown in FIGS. 1 and 4, the inner cover portion 172 is attached to the support portion 16 using a U-shaped double-sided adhesive tape 194 along the recess 162.

As schematically shown in FIG. 4, the gap 21 between the outer cover portion 171 and the light guide plate 14 is opened at the end on the negative-direction side of the X-axis, in which the double-sided adhesive tape 193 is not provided, and communicates with the space outside of the optical unit 1. The gap 22 between the inner cover portion 172 and the light guide plate 14, and the gap 20 between the inner cover portion 172 and the optical engine 1A are opened at the end on the negative-direction side of the X-axis, in which the double-sided adhesive tape 193 and the adhesive 191 are not provided, and communicate with the space outside of the optical unit 1 and also communicate with the outer space via the gap 23.

A light shielding portion 173 is provided in a region of the outer cover portion 171 that faces the incident-side HOE 151 on the light guide plate 14 or in an region of the outer cover portion 171 that faces a portion of the light guide plate 14 connected to the optical engine 1A in the Z-axis direction. The light shielding portion 173 covers the entire incident-side HOE 151. Alternatively, the projection of the light shielding portion 173 in the Z-axis direction covers the entire region, of the light guide plate 14, where the video light is incident from the optical engine 1A. The light shielding portion 173 may be achieved by a printed portion (e.g., black ink) provided on the outer cover portion 171 or may be achieved by a light shielding member disposed by sticking or the like to the outer cover portion 171.

The metal portion 18 is a metal member, and metal is exposed on its surface. The material of the metal portion 18 includes aluminum, for example. The metal portion 18 is a flat plate-like member and is disposed in the gap 21 between the light guide plate 14 and the outer cover portion 171. As schematically shown in FIG. 4, the metal portion 18 is attached to the outer cover portion 171 (specifically, light shielding portion 173) by a double-sided adhesive tape 195. The metal portion 18 is disposed so as to extend along the surface of the light guide plate 14. The metal portion 18 is disposed at a position overlapping with the light shielding portion 173 in the outer cover portion 171. When viewed from the Z-axis direction, the entire metal portion 18 overlaps with the light shielding portion 173. As shown in FIG. 4, a gap 210 is present between the metal portion 18 and the light guide plate 14 (or incident-side HOE 151).

The metal portion 18 is disposed so as to overlap with the video light incident from the optical engine 1A. The metal portion 18 is disposed such that the incident angle of the video light with respect to the metal portion 18 is larger than half of the angle of view of the video light. Hereinafter, description will be given with reference to FIGS. 5 and 6. FIG. 5 schematically shows a part of the optical unit 1 of a comparative example. FIG. 6 schematically shows a part of the optical unit 1 of this embodiment. In a case where the light guide plate 14 has translucency, the video light from the lens 13 is transmitted through the light guide plate 14 and incident on the surface of the metal portion 18. In a case where the surface of the metal portion 18 is parallel to the light guide plate 14, the incident angle of the video light with respect to the metal portion 18 can be regarded as equal to the incident angle of the video light with respect to the light guide plate 14. As shown in FIG. 5, in the comparative example, various members including the metal portion 18 are disposed such that the incident angle of the video light with respect to the light guide plate 14, i.e., the metal portion 18, is 0°. In contrast to this, as shown in FIG. 6, in this embodiment, various members including the metal portion 18 are disposed such that an incident angle θ2 of the video light with respect to the light guide plate 14, i.e., the metal portion 18, is larger than half (θ½) of the angle of view θ1 of the video light.

[1.2. Operation and Advantages of Optical Apparatus]

The configuration of the optical apparatus 1B according to this embodiment has been described so far. Subsequently, the operation and advantages of the optical apparatus 1B according to this embodiment will be described.

The optical engine 1A functions as a video input unit that inputs a video to the light guide plate 14. Note that the optical engine 1A may be connected to the light guide plate 14 or does not necessarily have to be connected thereto. In a case where the optical engine 1A is connected to the light guide plate 14, the light guide plate 14 including the optical engine 1A can be handled as a single optical unit 1.

FIG. 4 shows an exemplary optical path in the optical unit 1 by an arrow of a chain line. The incident-side HOE 151 diffracts the video light incident from the optical engine 1A to be transmitted to the light guide plate 14. The light guide plate 14 transmits the video light by using the total reflection due to the difference in refractive index with ambient air. Since the surfaces of the light guide plate 14 are in contact with air because of the presence of the gaps 20 to 22 between the light guide plate 14 and the cover portion 17 or the like, the light traveling inside the light guide plate 14 does not stop at the surface of the light guide plate 14, thus allowing total reflection. The emission-side HOE 152 changes the propagation state of the video light transmitted by the light guide plate 14. That is, the emission-side HOE 152 diffracts a specific wavelength of the video light and emits the diffracted wavelength light toward a pupil 30 of the user. The emission-side HOE 152 has a function of enlarging and displaying the video light as a virtual image. Note that the element that changes the propagation state of the video light guided by the light guide plate 14 and displays the video light as a virtual image to the user is not limited to the HOE and may be a half mirror. The half mirror is not limited to one disposed on the surface of the light guide plate 14 and may be a half mirror array embedded inside the light guide plate 14 in multilayer.

In a case where the light guide plate 14 has translucency, the optical apparatus 1B including the light guide plate 14 can be of a transmissive type. Thus, when the optical apparatus 1B is applied to an HMD, the HMD can be of a transmissive type. At that time, because of having optical transparency, the HOE 15 can be used as a transmissive display element. Specifically, among the light from the outside world (the positive-direction side of the Z-axis) that is incident on the emission-side HOE 152, a specific wavelength is diffracted but the remaining wavelength is transmitted. For that reason, the user sees the display video of the display 11 overlapping with an external scene. Note that the transmissive display element may be the half mirror described above.

The support portion 16 supports the light guide plate 14. The support portion 16 may be made of metal such as magnesium or may be made of resin. Resin is a relatively soft material. In a case where such a resin support portion 16 supports the glass light guide plate 14, the light guide plate 14 is hardly broken. Further, if the support portion 16 is made of resin, the weight of the optical apparatus 1B can be reduced. Note that the support portion 16 may have translucency or may have no translucency.

When moisture or the like adheres to the light guide plate 14 and the light guide plate 14 fogs, the light is less likely to be totally reflected and is scattered. This decreases the function of the light guide plate 14, makes it difficult for the video to reach the pupil 30 of the user, and causes a high possibility that the video quality deteriorates. In contrast to this, in the optical apparatus 1B of this embodiment, the cover portion 17 covers the light guide plate 14. Therefore, moisture or the like is prevented from adhering to the light guide plate 14, and the light guide plate 14 is thus protected.

Alternatively, when the skin of the user comes into contact with the light guide plate 14, moisture or the like may adhere to the light guide plate 14, and the function of the light guide plate 14 may decrease. In response to this, the cover portion 17 can also prevents the user from touching the light guide plate 14. Note that the cover portion 17 only needs to cover at least a part of the light guide plate 14, and thus the above-mentioned advantages are obtained. The cover portion 17 of this embodiment covers the entire light guide plate 14. Therefore, the function of the cover portion 17 that protects the light guide plate 14 can be improved as much as possible.

The cover portion 17 may be made of resin. In this case, even when the glass light guide plate 14 is broken by an impact applied to the optical apparatus 1B, or the like, the cover portion 17 is not broken. At that time, since the cover portion 17 can cover and hold the broken light guide plate 14 inside the cover portion 17, the cover portion 17 can sufficiently protect the user and others. Further, if the cover portion 17 is made of resin, the reduction in weight of the optical apparatus 1B can be achieved. Note that the cover portion 17 may be made of metal such as magnesium.

The cover portion 17 may be attached to the support portion 16. In this case, the cover portion 17, the support portion 16, and the light guide plate 14 can be handled as a single assembly (module). For example, since the module can be determined to be disposed or not to be disposed to correspond to each of the eyes of the user, the layout property of the optical apparatus 1B can be improved. Further, in a case where the cover portion 17 is attached to the support portion 16, the influence on the optical function of the light guide plate 14, i.e., on the transmission of video light by total reflection, can be reduced as compared with the case where the cover portion 17 is attached to the light guide plate 14 separately from the support portion 16. In other words, it is possible to allocate a large area of a portion where the light guide plate 14 functions as a light guide path, while reducing the size of the light guide plate 14.

The cover portion 17 may be attached to the support portion 16 via the double-sided adhesive tapes 193 and 194. When the cover portion 17 is indirectly attached to the support portion 16 in such a manner, the degree of freedom in designing the support portion 16 can be improved. Note that the cover portion 17 may be attached to the support portion 16 via, for example, an adhesive without being limited to an adhesive tape. Alternatively, a different member is provided between the cover portion 17 and the support portion 16, and each of the cover portion 17 and the support portion 16 may be attached to the different member. Meanwhile, the cover portion 17 may be directly attached to the support portion 16. For example, at least one of the outer cover portion 171 or the inner cover portion 172 may be formed integrally with the support portion 16 (in other words, as a single member).

The cover portion 17 may have translucency. For example, in the cover portion 17, a region located in a part or all of the field of view of the user may have translucency. In this case, the optical apparatus 1B including the cover portion 17 can be of a transmissive type. Thus, when the optical apparatus 1B is applied to the HMD, the HMD can be of a transmissive type. Note that at least a part of the cover portion 17 only needs to have translucency, whereby the advantages described above can be obtained. Note that the entire cover portion 17 may have translucency, or part of or all of the cover portion 17 may have no translucency.

The light shielding portion 173 may be provided to a part of the region having translucency in the cover portion 17. The light shielding portion 173 has a function of blocking a predetermined ratio or more of the light incident on the light shielding portion 173. In this case, the light shielding portion 173 prevents the video light, which comes from the optical engine 1A, from passing through the cover portion 17 and escaping to the outside of the optical apparatus 1B. Thus, it is possible to prevent a person other than the user from visually recognizing the video of the optical apparatus 1B, and it is also possible to prevent a person other than the user from seeing the transmitted video light as glare. Specifically, the light shielding portion 173 may be provided in a region of the outer cover portion 171 that faces the incident-side HOE 151 on the light guide plate 14 or in a region of the outer cover portion 171 that faces a portion of the light guide plate 14 connected to the optical engine 1A in the Z-axis direction. Thus, the light shielding portion 173 prevents the video light, which comes from the optical engine 1A, from passing through the cover portion 17 and escaping to the outside (the positive direction of the Z-axis) of the optical apparatus 1B, and thus the advantages described above can be effectively obtained. The light shielding portion 173 may cover, for example, the entire region of the cover portion 17 where the video light is incident from the optical engine 1A. Thus, the advantages described above can be obtained as much as possible.

In general, an adhesive is used in the optical apparatus 1B. The adhesive contains resin (particularly acrylic) and is easily hydrolyzed to generate an organic acid. Further, in the optical apparatus 1B, a resin that easily generates an organic acid as in the case of an adhesive is often used as a material. For example, an antireflection coat (AR coat) may be applied to the cover portion 17. The material of the AR coat includes an inorganic material and an organic material, and a method of dipping an organic material (e.g., resin) is advantageous in terms of cost. However, since the organic material of such an AR coat has a composition similar to that of an adhesive, an organic acid may be generated. Meanwhile, the light guide plate 14 is generally made of glass. The glass usually contains metal. Further, glass has such property that water easily adheres thereto. Thus, when an organic acid adheres to the light guide plate 14, this organic acid is easily hydrolyzed and easily becomes an organic acid metal. The organic acid metal causes fogging of the light guide plate 14 in addition to water droplets and the like. Note that glass purely consisting only of silicon dioxide SiO₂ is also conceivable, but it is costly.

Note that a method of coating the surface of the light guide plate 14 with an inorganic substance and suppressing the adhesion of an organic acid is also conceivable. However, in the method of coating the surface of the light guide plate 14, the manufacturing process of the light guide plate 14 becomes complicated, and the cost may be increased. Further, when the surface of the light guide plate 14 is coated, a surface treatment process of the light guide plate 14, for example, a process of forming the HOE 15 on the surface of the light guide plate 14 may be hindered. That is, when the surface of the light guide plate 14 is coated, adhesiveness of the photopolymer that is the material of the HOE 15 applied to the surface of the light guide plate 14 is impaired. Further, when the surface of the light guide plate 14 is coated, the angle of the surface of the photopolymer changes, and matching of the refractive index at the time of exposure becomes difficult. In such a manner, there is a possibility that the HOE 15 is difficult to produce.

In contrast to this, in the optical apparatus 1B of this embodiment, the metal portion 18 is disposed in the gap 21 between the light guide plate 14 and the outer cover portion 171. The metal portion 18 has a function of positively absorbing the organic acid generated in the optical apparatus 1B. This suppresses the organic acid from adhering to the light guide plate 14. Thus, since the occurrence of fogging on the light guide plate 14 is suppressed, lowering of the function of the light guide plate 14 is suppressed, and the performance of the optical apparatus 1B is easily maintained. Further, since there is no need to coat the surface of the light guide plate 14, the generation of fogging on the light guide plate 14 can be easily suppressed while the costs are suppressed, and the manufacturing of the HOE 15 can be facilitated. Note that the metal portion 18 may be disposed in the gap 22 between the light guide plate 14 and the inner cover portion 172. If the metal portion 18 is disposed between the cover portion 17 and at least one of the light guide plate 14 or the support portion 16, the advantages described above can be obtained.

The optical engine 1A may be attached to the light guide plate 14 by the adhesive 191. The adhesive 191 may generate an organic acid. The metal portion 18 absorbs the organic acid generated by the adhesive 191, and thus adhesion of the organic acid to the light guide plate 14 is suppressed. This makes it easy to maintain the performance of the optical apparatus 1B including the optical engine 1A. Note that the optical engine 1A may be attached to the light guide plate 14 by an adhesive tape or the like instead of the adhesive 191.

The HOE 15 may be disposed in the gap 21 (first gap) between the light guide plate 14 and the outer cover portion 171. Since the HOE 15 is made of resin such as a photopolymer, the HOE 15 may generate an organic acid. As described above, the organic acid generated from the HOE 15 and staying in the gap 21 is absorbed by the metal portion 18, so that the organic acid described above is suppressed from adhering to the light guide plate 14. This makes it easy to maintain the performance of the optical apparatus 1B including the HOE 15. Note that the HOE 15 may be disposed in the gap 22 (first gap) between the light guide plate 14 and the inner cover portion 172. Further, not only the HOE 15 but also an element for changing the propagation state of light transmitted in the light guide plate 14, such as a half mirror, only needs to be disposed in the gap 21 or the gap 22. When such an element generates an organic acid, the metal portion 18 absorbs the organic acid, so that the advantages described above can be obtained.

The material of the metal portion 18 is not limited to aluminum and may include general metal such as magnesium. Using aluminum as the material of the metal portion 18 can reduce the cost of the metal portion 18 and facilitate handling. Note that, depending on the type of the generated organic acid (acetic acid or the like), metal species that are easy to react with the organic acid may be selected as the material of the metal portion 18. When a plurality of types of organic acids is generated, a plurality of metal species may be used as the material of the metal portion 18. The metal portion 18 is not limited to a single metal portion 18 but may be multiple metal portions 18. In the case of using the plurality of metal portions 18, the respective materials (metal species) may be different from each other.

The metal portion 18 may have a planar shape. In this case, the surface area of the metal portion 18 can be easily increased, and the absorption efficiency of the organic acid can be improved. Further, it is possible to improve the workability of disposing the metal portion 18, such as attaching the metal portion 18 to an appropriate portion using the double-sided adhesive tape 195. Further, the configuration of the metal portion 18 can be simplified by the planar shape. Note that the surface area per volume of the metal portion 18 may be increased by, for example, bending and deforming the planar metal portion 18. In other words, the metal portion 18 does not need to be planar as a whole. Further, the metal portion 18 may be disposed on another member (cover 17 or the like) by vapor deposition or may be formed or disposed by printing of a metal paste (screen, jet, or the like).

The metal portion 18 may be attached to a portion hidden by the support portion 16 when a person other than the user views the optical apparatus 1B from the outside. Thus, the appearance of the optical apparatus 1B can be improved. This is effective because the metal portion 18 is easily hidden by the support portion 16, particularly when the support portion 16 has no translucency. Further, the metal portion 18 may be attached so as to frame the outer edge of the light guide plate 14 or the support portion 16. Thus, the appearance of the optical apparatus 1B can be improved. This is effective because the metal portion 18 is easily used as a part of the design of the optical apparatus 1B, particularly when the support portion 16 has translucency. In addition, the metal portion 18 may be arranged in a mesh shape with a fine pitch or in a dot shape in a portion having translucency of the cover portion 17. In those cases, it is possible to efficiently increase the surface area of the metal portion 18 while ensuring the translucency of the portion of the cover portion 17. Further, it is easy to maintain the appearance of the optical apparatus 1B.

The metal portion 18 may be disposed at a portion where the concentration of the organic acid tends to be high. In this case, the metal portion 18 can efficiently absorb the organic acid. For example, it can be said that the concentration of the organic acid tends to be high in the vicinity of the portion where the organic acid is generated (specifically, the adhesives 191 and 192, the HOE 15, the AR coat of the cover portion 17, and the like). Further, since the organic acid is easily generated in the high-temperature portion (for example, in the optical engine 1A), it can be said that the concentration of the organic acid tends to be high in that portion. Further, the air inside the optical apparatus 1B is likely to flow from the high-temperature portion side to the low-temperature portion side. In addition, if a ventilation passage for communicating the gaps 21, 210, and 22 between the light guide plate 14 and the cover portion 17 or the like to the outside of the optical apparatus 1B is provided, part of the organic acid inside the optical apparatus 1B can escape to the outside together with the air through the ventilation passage. The airflow inside the optical apparatus 1B, i.e., the portion where the organic acid tends to stay, depends also on the presence or absence of such a ventilation passage or the arrangement thereof. In consideration of such airflow, a portion where the metal portion 18 can most efficiently absorb the organic acid may be specified by an experiment or the like, and the metal portion 18 may be disposed at that portion.

For example, the cover portion 17 may be attached to the support portion 16 by the U-shaped double-sided adhesive tapes 193 and 194 so as to surround the outer periphery of the light guide plate 14. The double-sided adhesive tapes 193 and 194 are not provided to the end of the cover portion 17 in the negative-direction side of the X-axis. In such a manner, the gap between the portion of the cover portion 17 where the double-sided adhesive tapes 193 and 194 are not provided and the light guide plate 14 or the support portion 16 (for example, the gap 24 shown in FIG. 4) can function as the ventilation passage. Further, as shown in FIG. 4, the gap 23 is provided between the optical engine 1A and the inner cover portion 172. The gap 23 can function as the ventilation passage.

The adhesive 191 for bonding the optical engine 1A and the light guide plate 14 may be provided to only a part of the outer periphery of a portion of the optical engine 1A, the portion facing the light guide plate 14. In this case, the gap 20 between the above-mentioned portion of the optical engine 1A and the light guide plate 14 communicates with the outside through the gap between the light guide plate 14 and a portion, in which the adhesive 191 is not provided, of the outer periphery of the above-mentioned portion of the optical engine 1A. Thus, the gap 20 can function as the ventilation passage. For example, the adhesive 191 does not need to be provided to the end on the negative-direction side of the X-axis in the outer periphery of the above-mentioned portion of the optical engine 1A. In this case, the gap 20 communicates with the outside through the gap between the light guide plate 14 and the portion, in which the adhesive 191 is not provided, of the outer periphery of the above-mentioned portion of the optical engine 1A. The adhesive 191 does not need to be provided to the end on the positive-direction side of the X-axis in the outer periphery of the above-mentioned portion of the optical engine 1A. In this case, the gap 20 communicates with the outside through the gap between the light guide plate 14 and the portion, in which the adhesive 191 is not provided, of the outer periphery of the above-mentioned portion of the optical engine 1A, and the gap 23 between the optical engine 1A and the inner cover portion 172. Note that the double-sided adhesive tape 193 may be partially cut. In this case, the gap 21 between the outer cover portion 171 and the light guide plate 14 can communicate with the space outside the optical apparatus 1B through the gap in the cut portion of the double-sided adhesive tape 193. Similarly, the double-sided adhesive tape 194 may be partially cut. In this case, the gap 22 between the inner cover portion 172 and the light guide plate 14 can communicate with the space outside the optical apparatus 1B through the gap in the cut portion of the double-sided adhesive tape 194.

The gaps 20, 23, 24, and the like (second gap) described above have a function as a ventilation passage for discharging the organic acid generated inside the optical apparatus 1B to the outside and also have a function of ensuring a clearance when the metal portion 18 or the like expands by heat. However, the present inventor has found that the occurrence of haze on the light guide plate 14 due to the organic acid fails to be sufficiently suppressed even by the ventilation function of those gaps. The metal portion 18 positively absorbs the organic acid as described above and can thus compensate for a shortage of the ventilation function of the gaps described above or substitute as the ventilation function.

The metal portion 18 may be attached to the cover portion 17. In this case, the influence on the function of the light guide plate 14, i.e., on the transmission of video light by total reflection, can be reduced as compared with the case where the metal portion 18 is attached to the light guide plate 14. In other words, it is possible to ensure a large area of a portion where the light guide plate 14 functions as a light guide path while reducing the size of the light guide plate 14. The metal portion 18 may be attached to the outer cover portion 171 via the double-sided adhesive tape 195. When the metal portion 18 is indirectly attached to the outer cover portion 171 in such a manner, the degree of freedom in designing the outer cover portion 171 can be improved. The metal portion 18 may be directly attached to the outer cover portion 171. For example, the metal portion 18 may be integrated with the outer cover portion 171 made of resin by insert molding. Similarly, the metal portion 18 may be attached directly or indirectly to the inner cover portion 172. Further, the metal portion 18 may also be attached directly or indirectly to the support portion 16. Also in this case, the advantages similar to those obtained when the metal portion 18 is attached to the cover portion 17 are obtained.

The positional relationship between the metal portion 18 and the light shielding portion 173 may be determined such that the light shielding portion 173 covers the metal portion 18. In this case, since the metal portion 18 is covered with the light shielding portion 173 and hidden from the eyes of a person other than the user, the appearance of the optical apparatus 1B can be improved. Further, when the metal portion 18 is attached to the cover portion 17, it is possible to facilitate the mounting process of the metal portion 18. For example, even when the position of the metal portion 18 is slightly displaced or the metal portion 18 is slightly deformed, less problem is caused from the viewpoint of appearance as long as the metal portion 18 is covered with the light shielding portion 173. Note that, if the light shielding portion 173 covers at least a part of the metal portion 18, the advantages described above can be obtained. The light shielding portion 173 of this embodiment covers the entire metal portion 18. Therefore, the above-mentioned advantages can be obtained as much as possible. Note that, in a case where the metal portion 18 is directly attached to the cover portion 17, the light shielding portion 173 and the metal portion 18 are made as a common component, and thus the above-mentioned configuration in which the light shielding portion 173 covers the metal portion 18 can be substantially obtained. That is, metal does not have translucency and can thus function as the light shielding portion 173. For example, in a case where the light shielding portion 173 has a layer structure in which a printed layer of black ink and a layer of metal (for example, silver) overlap with each other, the metal layer can be replaced by the metal portion 18.

The metal portion 18 may be disposed so as to overlap with video light incident from the optical engine 1A and also to form a predetermined angle with respect to the video light. In other words, the surface of the metal portion 18 to overlap with the video light may form a predetermined angle with respect to the video light. In this case, the video light is suppressed from being reflected on the metal portion 18 to be stray light. That is, when the angle of the metal portion 18 with respect to the video light is adjusted, the reflected light of the video light from the metal portion 18 is suppressed from returning to the optical engine 1A or the inside of the light guide plate 14 to produce a ghost image. In particular, in a case where a volume-type HOE 15 is used, a diffraction width (i.e., angle) at which images are obtained is relatively narrow and limited. Therefore, when the angle of the metal portion 18 is adjusted, it is possible to effectively avoid stray light.

Specifically, as shown in FIG. 6, the surface of the metal portion 18 may be disposed such that the incident angle θ2 of the video light with respect to the metal portion 18 is larger than half of the angle of view θ1 of the video light. In this case, the reflected light of the video light from the metal portion 18 can be more reliably suppressed from returning to the optical engine 1A or the inside of the light guide plate 14.

### Second Embodiment

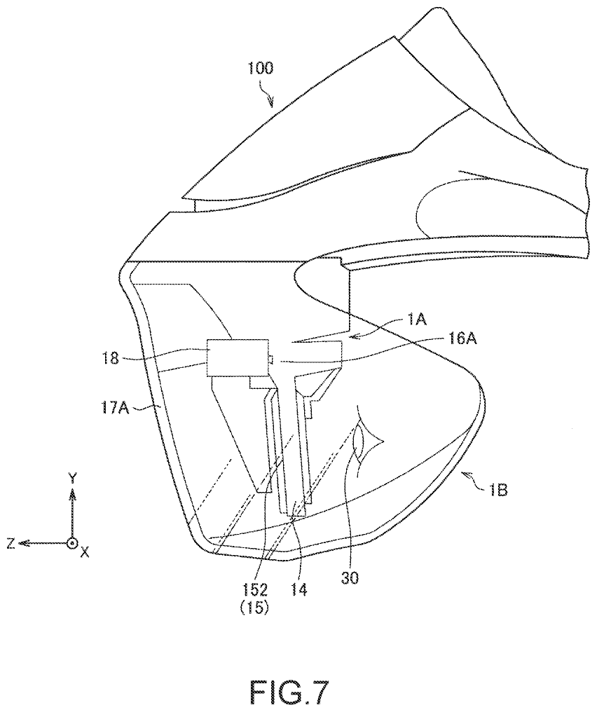

Next, an optical apparatus 1B of a second embodiment will be described with reference to FIG. 7. Configurations common to those of the first embodiment will be denoted by the same reference signs as those of the first embodiment, and description thereof will be omitted.

The optical apparatus 1B according to this embodiment is used for a transmissive HMD. The HMD has a front block 100 to be mounted on the front head part of a user, a rear block to be mounted on the rear head part of the user, and a connecting member for connecting the front block and the rear block. FIG. 7 is a partial side view of the front block 100 of the HMD. The front block 100 includes an optical engine 1A and the optical apparatus 1B. The rear block includes a battery for supplying power necessary to operate the optical engine 1A and a control board for controlling the operation of the optical engine 1A.

The optical apparatus 1B includes a light guide plate 14, a HOE 15, a support portion 16A, a cover portion 17A, and a metal portion 18. The support portion 16A does not have a frame shape surrounding the light guide plate 14, and is attached by an adhesive or the like to the outer edge on the positive-direction side of the Y-axis in the outer edge of the light guide plate 14 and supports the light guide plate 14 so as to hang it from above (the positive-direction side of the Y-axis). The cover portion 17A is provided in a three-dimensional shape covering the upper portion of the user's face including the eyes, below the front block 100 (the negative-direction side of the Y-axis). The cover portion 17A has translucency and functions as a visor of the HMD. With the front block 100 being mounted on the head of the user, an emission-side HOE 152 is disposed in front (the positive-direction side of the Z-axis) of a pupil 30 of the user. Note that the optical apparatus 1B may be provided to correspond to both eyes of the user or may be provided to correspond to only one eye of the user.

The metal portion 18 is disposed at a position between the support portion 16A and the cover portion 17A outside the field of view of the user, for example, at a position shown in FIG. 7. The metal portion 18 has, for example, a planar shape, and may be attached to the inner surface of the cover portion 17A by a double-sided adhesive tape or the like.

As described above, in this embodiment, in the optical apparatus 1B used in the transmissive HMD, the metal portion 18 is disposed at a position inside the cover portion 17A and outside the field of view of the user. Thus, the metal portion 18 can achieve the above-mentioned function of absorbing the organic acid without hindering the field of view of the user. Note that the metal portion 18 is disposed without being limited to the position shown in FIG. 7, and only needs to be disposed between the cover portion 17A and at least one of the light guide plate 14 or the support portion 16A, thereby exhibiting the function of absorbing the organic acid. Further, the metal portion 18 only needs to be disposed at a position outside the field of view of the user, and thus the advantage of not hindering the field of view of the user is obtained.

The suitable embodiments of the present disclosure have been described in detail above with reference to the accompanying drawings, but the technical scope of the present disclosure is not limited to such examples. It is obvious that a person having an ordinary skill in the art of the present disclosure could have conceived various changes or modifications within the scope of the technical ideas described in the scope of claims, and it is understood that these changes or modifications also belong to the technical scope of the present disclosure as a matter of course.

Further, the effects described herein are merely illustrative or exemplary and not restrictive. In other words, the technology according to the present disclosure may have other effects apparent to those skilled in the art in light of the description of this specification together with the above-mentioned effects or in place of the above-mentioned effects.

Note that the following configurations may also belong to the technical scope of the present disclosure.

(1) An optical apparatus, including:

a light guide plate;

a support portion that supports the light guide plate;

a cover portion that covers at least a part of the light guide plate; and

a metal portion disposed between the cover portion and at least one of the light guide plate or the support portion.

(2) The optical apparatus according to (1), in which

the light guide plate is made of glass.

(3) The optical apparatus according to (1) or (2), further including

a first gap between the light guide plate and the cover portion, an element for changing a propagation state of light transmitted in the light guide plate being disposed in the first gap.

(4) The optical apparatus according to (3), further including

a second gap that causes the first gap to communicate with an outside of the optical apparatus.

(5) The optical apparatus according to (3) or (4), in which

the element for changing a propagation state of light transmitted in the light guide plate is a holographic optical element.

(6) The optical apparatus according to any one of (1) to (5), in which

the metal portion is directly or indirectly attached to the cover portion.

(7) The optical apparatus according to any one of (1) to (6), in which

the metal portion has a flat shape.

(8) The optical apparatus according to any one of (1) to (7), in which

the support portion is made of resin.

(9) The optical apparatus according to any one of (1) to (8), in which

the cover portion is directly or indirectly attached to the support portion.

(10) The optical apparatus according to any one of (1) to (9), in which

the cover portion is made of resin.

(11) The optical apparatus according to any one of (1) to (10), in which

the cover portion has translucency in at least a part thereof.

(12) The optical apparatus according to (11), in which

the cover portion includes a light shielding portion in a part of a region having translucency, and

the light shielding portion covers at least a part of the metal portion.

(13) The optical apparatus according to (12), in which

the light shielding portion covers an entire metal portion.

(14) The optical apparatus according to any one of (1) to (13), in which

the metal portion is disposed to overlap with video light incident from an video input unit and to form a predetermined angle with respect to the video light.

(15) The optical apparatus according to (14), in which

an incident angle of the video light with respect to the metal portion is larger than half of an angle of view of the video light.

(16) The optical apparatus according to (14) or (15), in which

the video input unit is connected to the light guide plate.

(17) The optical apparatus according to (16), in which

the video input unit is attached to the light guide plate by using an adhesive.

(18) A display apparatus, including:

a light guide plate;

a support portion that supports the light guide plate;

a cover portion that covers at least a part of the light guide plate; and

a metal portion disposed between the cover portion and at least one of the light guide plate or the support portion.

(19) The display apparatus according to (18), which is a head mounted display to be mounted on a head of a user.
(20) The display apparatus according to (18) or (19), in which

the light guide plate is made of glass.

(21) The display apparatus according to any one of (18) to (20), further including

a first gap between the light guide plate and the cover portion, an element for changing a propagation state of light transmitted in the light guide plate being disposed in the first gap.

(22) The display apparatus according to (21), further including

a second gap that causes the first gap to communicate with an outside of the display apparatus.

(23) The display apparatus according to (21) or (22), in which

the element for changing a propagation state of light transmitted in the light guide plate is a holographic optical element.

(24) The display apparatus according to any one of (18) to (23), in which

the metal portion is directly or indirectly attached to the cover portion.

(25) The display apparatus according to any one of (18) to (24), in which

the metal portion has a flat shape.

(26) The display apparatus according to any one of (18) to (25), in which

the support portion is made of resin.

(27) The display apparatus according to any one of (18) to (26), in which

the cover portion is directly or indirectly attached to the support portion.

(28) The display apparatus according to any one of (18) to (27), in which

the cover portion is made of resin.

(29) The display apparatus according to any one of (18) to (28), in which

the cover portion has translucency in at least a part thereof.

(30) The display apparatus according to (29), in which

the cover portion includes a light shielding portion in a part of a region having translucency, and

the light shielding portion covers at least a part of the metal portion.

(31) The display apparatus according to (30), in which

the light shielding portion covers an entire metal portion.

(32) The display apparatus according to any one of (18) to (31), in which

the metal portion is disposed to overlap with video light incident from an video input unit and to form a predetermined angle with respect to the video light.

(33) The display apparatus according to (32), in which

an incident angle of the video light with respect to the metal portion is larger than half of an angle of view of the video light.

(34) The display apparatus according to (32) or (33), in which

the video input unit is connected to the light guide plate.

(35) The display apparatus according to (34), in which

the video input unit is attached to the light guide plate by using an adhesive.

### REFERENCE SIGNS LIST

1A optical engine (video input unit)
1B optical apparatus
14 light guide plate
15 holographic optical element
16 support portion
17 cover portion
173 light shielding portion
18 metal portion
191 adhesive

1. An optical apparatus, comprising:
a light guide plate;
a support portion that supports the light guide plate;
a cover portion that covers at least a part of the light guide plate; and
a metal portion disposed between the cover portion and at least one of the light guide plate or the support portion.

2. The optical apparatus according to claim 1, wherein
the light guide plate is made of glass.

3. The optical apparatus according to claim 1, further comprising
a first gap between the light guide plate and the cover portion, an element for changing a propagation state of light transmitted in the light guide plate being disposed in the first gap.

4. The optical apparatus according to claim 3, further comprising
a second gap that causes the first gap to communicate with an outside of the optical apparatus.

5. The optical apparatus according to claim 3, wherein
the element for changing a propagation state of light transmitted in the light guide plate is a holographic optical element.

6. The optical apparatus according to claim 1, wherein
the metal portion is directly or indirectly attached to the cover portion.

7. The optical apparatus according to claim 1, wherein
the metal portion has a flat shape.

8. The optical apparatus according to claim 1, wherein
the support portion is made of resin.

9. The optical apparatus according to claim 1, wherein
the cover portion is directly or indirectly attached to the support portion.

10. The optical apparatus according to claim 1, wherein
the cover portion is made of resin.

11. The optical apparatus according to claim 1, wherein
the cover portion has translucency in at least a part thereof.

12. The optical apparatus according to claim 11, wherein
the cover portion includes a light shielding portion in a part of a region having translucency, and
the light shielding portion covers at least a part of the metal portion.

13. The optical apparatus according to claim 12, wherein
the light shielding portion covers an entire metal portion.

14. The optical apparatus according to claim 1, wherein
the metal portion is disposed to overlap with video light incident from an video input unit and to form a predetermined angle with respect to the video light.

15. The optical apparatus according to claim 14, wherein
an incident angle of the video light with respect to the metal portion is larger than half of an angle of view of the video light.

16. The optical apparatus according to claim 14, wherein
the video input unit is connected to the light guide plate.

17. The optical apparatus according to claim 16, wherein
the video input unit is attached to the light guide plate by using an adhesive.

18. A display apparatus, comprising:
a light guide plate;
a support portion that supports the light guide plate;
a cover portion that covers at least a part of the light guide plate; and
a metal portion disposed between the cover portion and at least one of the light guide plate or the support portion.

19. The display apparatus according to claim 18, which is a head mounted display to be mounted on a head of a user.
